(19) United States
(12) Patent Application Publication
(10) Pub. No.: US 2004/0070344 A1
(43) Pub. Date: Apr. 15, 2004

(54) Cold cathode lamp and electronic instrument using cold cathode lamp

(75) Inventors: Seiichiro Fujioka, Tokyo (JP); Yasuki Kawashima, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 10/630,838

(22) Filed: Jul. 31, 2003

(30) Foreign Application Priority Data
Aug. 5, 2002 (JP) 226985/2002

(51) Int. Cl. H01J 17/04

(52) U.S. Cl. 313/633; 313/631

(57) ABSTRACT

A cold cathode lamp according to the present invention provide with: electrodes fixed on respective ends of a glass tube; filling a rare gas or a rare gas and mercury vapor in the glass tube; and at least surfaces of the electrodes are composed the nitride, said nitride is composed at least one of titanium (Ti), zirconium (Zr), hafnium (Hf), niobium (Nb) and tantalum (Ta).

### BACKGROUND OF THE INVENTION

1. Field of the Invention

The present invention relates to a cold cathode lamp having improved electrodes, and an electronic instrument using such a cold cathode lamp.

2. Description of the Related Art

The enhancement of the luminance of liquid-crystal displays and the elevation of the speed of image scanners have required cold cathode lamps, which are the light source for these instruments to have high luminance, and the cold cathode lamps have coped with this problem by increasing lamp currents.

However, increase in the lamp current also increases load to electrodes. Also since the electrodes of conventional cold cathode lamps use nickel, the evaporation (sputtering) rate of the electrode materials rises, the required life cannot be maintained due to the wear of the electrodes, or the formation of amalgam through the reaction of the evaporated materials with mercury.

If the electrodes are enlarged to cope with this problem, the non-luminous portions are also enlarged, and cannot be mounted in the instrument.

Furthermore, a longer life of liquid-crystal displays and image scanners has demanded because of the tendency to maintenance-free use, and conventional electrodes have not been able to cope with the requests for high luminance and long life.

As described above, conventional cold cathode lamps have no longer achieved the high luminance of liquid-crystal displays to increase the speed of image scanners, and sufficiently longer life.

### SUMMARY OF THE INVENTION

An object of the present invention is to provide a cold cathode lamp of high luminance and long life having a short non-luminous portion.

Another object of the present invention is to provide an electronic instrument using a cold cathode lamp of high luminance and long life having a short non-luminous portion.

The cold cathode lamp of the present invention is characterized in a cold cathode lamp comprising electrodes fixed on the respective ends of a glass tube, and containing a rare gas or a rare gas and mercury vapor therein, wherein at least the surfaces of the electrodes are comprised the nitride, which is composed at least one of titanium (Ti), zirconium (Zr), hafnium (Hf), niobium (Nb) and tantalum (Ta).

Therefore, since the cold cathode lamp of the present invention has electrodes that have a work function lower than the work function of nickel (Ni), can flow more lamp currents in the same shape and the same size, have a lower sputtering rate than Ni to reduce the wear of the electrodes, and little form amalgam with mercury, the present invention can provide a cold cathode lamp of high luminance and long life having a short non-luminous portion.

Furthermore, the electronic instrument of the present invention is characterized in the constitution using a cold cathode lamp having electrodes fixed on the respective ends of a glass tube, and containing a rare gas or a rare gas and mercury vapor therein, wherein at least the surfaces of the electrodes are comprised the nitride, which is composed at least one of Ti, Zr, Hf, Nb and Ta.

Therefore, since the electronic instrument of the present invention uses a cold cathode Lamp having electrodes that have a work function lower than the work function of nickel (Ni), can flow more lamp currents in the same shape and the same size, have a lower sputtering rate than Ni to reduce the wear of the electrodes, and little form amalgam with mercury, the present invention can provide an electronic instrument of high luminance and long life having a short non-luminous portion.

### BRIEF DESCRIPTION OF THE DRAWINGS

The above and other objects, features and advantages of the present invention will become more apparent from the following detailed description when taken in conjunction with the accompanying drawing wherein:

FIG. 1 is a side view including a partly sectional view showing a cold cathode lamp according to the present invention;

FIG. 2 is a perspective view showing that the electrodes of a cold cathode lamp according to the present invention are bar-shaped;

FIG. 3 is a perspective view showing that the electrodes of a cold cathode lamp according to the present invention are tubular;

FIG. 4 is a perspective view showing that the electrodes of a cold cathode lamp according to the present invention are cup-shaped;

FIG. 5 is a sectional view showing that the cross section of the glass tube in a cold cathode lamp according to the present invention perpendicular to the length direction thereof has a true-round ring shape;

FIG. 6 is a sectional view showing that the cross section of the glass tube in a cold cathode lamp according to the present invention perpendicular to the length direction thereof has a rectangular ring shape;

FIG. 7 is a side view schematically showing a display unit according to the first embodiment of the present invention;

FIG. 8 is a perspective view showing a reading unit according to the second embodiment of the present invention; and

FIG. 9 is a sectional view along the B-B portion of a reading unit according to the second embodiment of the present invention.

### DETAILED DESCRIPTION OF THE PREFERRED EMBODIMENTS

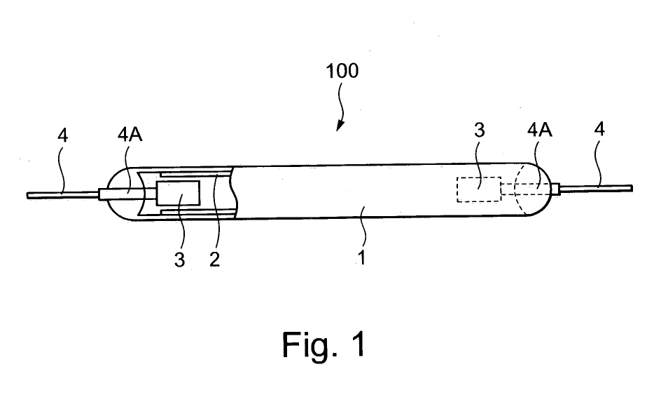

The present invention will be described below referring to the drawings. FIG. 1 is a side view including a partly sectional view showing a cold cathode lamp 100 according to the present invention.

Leads 4 of an Ni—Cr—Fe alloy are sealed in a glass tube 1 of an outer diameter of 2 mm to 4 mm, a thickness of 0.4 mm to 0.6 mm, and a length of 50 mm to 300 mm; and a layer of a fluorescent material 2 is formed on the internal surface of the glass tube 1.

The gas filling the glass tube 1 is a rare gas, or a rare gas and mercury vapor, and the internal gas pressure is 1,300 Pa to 20,000 Pa.

In the glass tube 1, electrodes 3 of the present invention are connected to the connecting portions 4A of the leads 4, which are the portions of the leads 4 whose diameters are thickened. The method of this connection may be selected from the mechanical calking of the connecting portions 4A and electrodes 3, welding, or the like. Non-luminous portions are composed the connecting portions 4A of the leads 4 and electrodes 3.

At least the surfaces of the electrodes 3 are comprised the nitride, which is composed at least one of titanium (Ti), zirconium (Zr), hafnium (Hf), niobium (Nb) and tantalum (Ta) The nitride which is composed at least one of titanium (Ti), zirconium (Zr), hafnium (Hf), niobium (Nb) and tantalum (Ta) has a work function lower than the work function of nickel, flows more lamp currents in the same shape and the same size, has the sputtering rate lower than Ni to reduce the wear of the electrodes, and little forms amalgam with mercury. Therefore, the cold cathode lamp having high luminance and long life that can flow much lamp current can be formed without enlarging the electrodes.

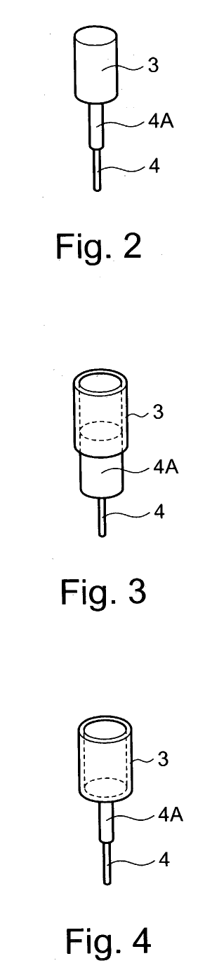

An electrode 3 will be described below referring to FIGS. 2 to 4

FIG. 2 is a perspective view showing a bar-shaped electrode 3, and the state wherein the connecting portion 4A of the lead 4 is connected to an end of the electrode 3. The electrode 3 can be obtained by cutting the material which is composed at least one of Ti, Zr, Hf, Nb and Ta into a bar shape, placing it in an oven or the like filled with N (nitrogen), and heating it to cause a chemical reaction to form a nitrogen-treated layer on the surface.

Alternatively, the electrode 3 can be obtained by cutting the nitride which is composed at least one of Ti, Zr, Hf, Nb and Ta into a bar shape.

Further alternatively, the electrode 3 can be obtained by cutting other electrode metal, for example Ni, into a bar shape, and coating the surface thereof with the nitride, which is composed at least one of Ti, Zr, Hf, Nb and Ta.

FIG. 3 is a perspective view showing a tubular electrode 3, and the state wherein the connecting portion 4A of the lead 4 is inserted through and connected to an end of the electrode 3. The electrode 3 can be obtained by pressing a plate material which is composed at least one of Ti, Zr, Hf, Nb and Ta into a tubular shape, placing it in an oven or-the like filled with nitrogen (N), and heating it to cause a chemical reaction to form a nitrogen-treated layer on the surface.

Alternatively, the electrode 3 can be obtained by pressing other electrode metal, for example Ni, into a tubular shape, and sputtering, or vapor-depositing the nitride which is composed at least one of Ti, Zr, Hf, Nb and Ta on the surface of the tubular Ni.

FIG. 4 is a perspective view showing a cup-shaped electrode 3, and the state wherein the connecting portion 4A of the lead 4 is connected to bottom of the cup-shaped electrode 3. The electrode 3 can be obtained by pressing a plate material which is composed at least one of Ti, Zr, Hf, Nb and Ta into a cup shape, placing it in an oven or the like filled with N, and heating it to cause a chemical reaction to form a nitrogen-treated layer on the surface.

Alternatively, the electrode 3 can be obtained by pressing other electrode metal, for example Ni, into a cup shape, and sputtering or vapor-depositing the nitride, which is composed at least one of Ti, Zr, Hf, Nb and Ta on the surface of the cup-shaped Ni.

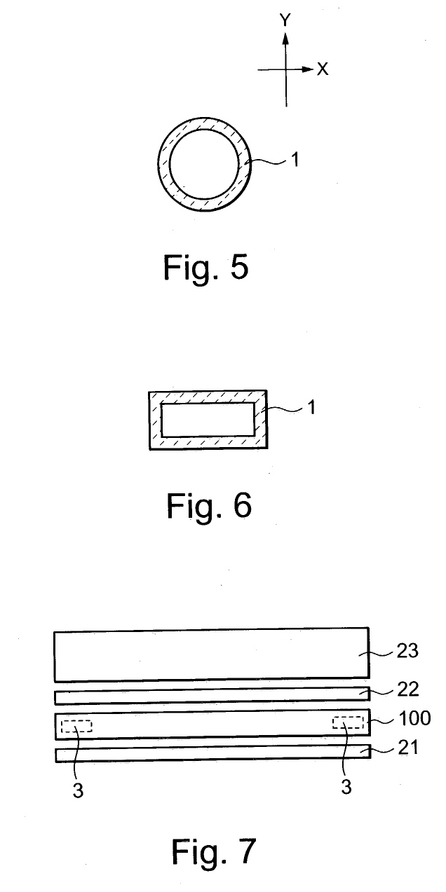

Next, the glass tube 1 wherein the electrodes 3 of the present invention is incorporated will be described referring to FIGS. 5 and 6. FIGS. 5 and 6 are sectional views showing the cross sections of glass tubes perpendicular to the length direction of the glass tubes.

FIG. 5 shows the case of a glass tube 1 of a true-round ring shape having the cross section wherein the dimensions in the X-direction and the Y-dimension are identical, and this glass tube has the advantage that the fabrication is easy.

FIG. 6 shows the case of a glass tube 1 of a rectangular ring shape having the,cross section wherein the dimensions in the X-direction is longer than the dimensions in the Y-direction, and although the glass tube 1 of a rectangular ring shape is shown in FIG. 6, a glass tube 1 may be of an oval ring shape, and can constitutes a flat-type lamp. These glass tubes have advantages to enable even illumination throughout the illuminated area of the flat-type lamp by placing the illuminated area in parallel to the major face of the glass tube 1 extending in the X-direction.

The effect of the present invention will be explained comparing to the conventional lamps.

Table 1 shows the luminous intensities of respective cold cathode lamps as a basis of 100% of the initial luminous intensity of the conventional lamp C1.

TABLE 1
Luminous Intensity Of Cold Cathode Lamps

| | Elec- | Length of non- | Lighting hour of lamp | | |
|---|---|---|---|---|---|
| Lamp | trode | luminous portion | 0 hour | 500 hours | 3000 hours |
| C1 | Ni | L = 4 (mm) | 100.00% | 93.79% | 87.10% |
| C2 | Ni | L = 5 (mm) | 98.83% | 95.47% | 91.27% |
| E1 | TiN | L = 4 (mm) | 100.21% | 97.67% | 94.43% |
| E2 | ZrN | L = 4 (mm) | 100.29% | 96.41% | 94.33% |

The conventional lamp C1 is the cold cathode lamp having the Ni electrodes. The length of the non-luminance portion in the lamp C1 is 4 mm.

The conventional lamp C2 is the cold cathode lamp having the Ni electrodes. The length of the non-luminance portion in the lamp C2 is 5 mm.

The embodiment cold cathode lamp E1 of the present invention has the electrodes comprised the nitride of Ti (TiN) and the non-luminance portion length in the lamp E1 is 4 mm.

The embodiment cold cathode lamp E2 of the present invention has the electrodes comprised the nitride of Zr (ZrN), and the non-luminance portion length in the lamp E2 is 4 mm.

At first, initial luminous intensities (i.e., “0 hour” in the Table 1) of the respective cold cathode lamps were compared. As the result the initial luminous intensity of the lamps C2, E1 and E2 were 98.83%, 100.21% and 100.29% respectively. As described above, the initial luminous intensity of the conventional lamp C1 is regarded as 100%.

Therefore, it was confirmed that the initial luminous intensities of the embodiment lamps E1 and E2 were improved compared to the conventional lamps C1 and C2

Then, the decrease in the luminous intensity of the respective cold cathode lamps was measured in order to compare the sustainability of lamps (i.e., life). The sustainability is valued by the reduction of the luminous intensity after 3000 hours of lightning.

As a result, the reduction of the luminous intensity of the lamps C1, C2, E1 and E2 were 12.90% (=100−87.10), 7.56% (=98.83−91.27), 5.78% (=100.21−94.43) and 5.96% (=100.29−94.33), respectively.

Therefore, it was confirmed that the sustainability of the luminous intensity of the embodiment lamps E1 and E2 is improved compared to the conventional lamps C1 and C2.

FIG. 7 is a diagram showing a display unit, which is an electronic instrument using a cold cathode lamp of the present invention. A liquid-crystal display is constituted by forming picture elements in a matrix between a pair of glass substrates using a transparent electrode, a liquid-crystal layer, a sealing material, an orientation film, a gap material and the like, and installing a backlight mechanism consisting of a light-diffusion plate 22, the cold cathode lamp 100 of the present invention, and a reflection plate 21 on the backside (lower side in the drawing) of the liquid-crystal panel 23 equipped with a deflection plate. A light guide plate may be formed between the light-diffusion plate 22 and the reflection plate 21, and the cold cathode lamp 100 of the present invention may be placed on the side of the light guide plate.

As described above, since at least the surfaces of the electrodes 3 of the cold cathode lamp 100 of the present invention are comprised the nitride which is composed Ti, Zr, Hf, Nb and Ta, it is a cold cathode lamp having a high luminance and a long life.

In general, although liquid-crystal displays, which are household appliances, are maintenance-free, that is, the liquid-crystal displays are discarded when the cold cathode lamps are deteriorated without replacing the cold cathode lamps, the liquid-crystal display, which is a display unit of the present invention, has a high performance since a high-luminance cold cathode lamp is used, and can be used for a long period of time since a long-life cold cathode lamp is used.

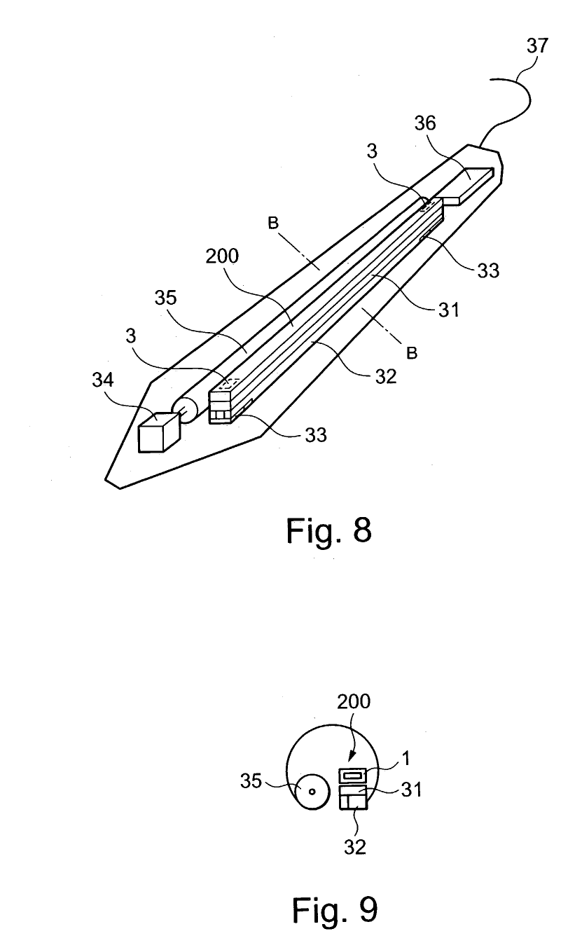

FIGS. 8 and 9 are diagrams showing a pen-type image scanner of a reading unit, which is an electronic instrument using a cold cathode lamp according to the second embodiment of the present invention. The image scanner is equipped with an image sensor element 31, a frequency application panel 32, a black/white reference plate 33, an encoder 34, a roll 35, a circuit board 36, and a cable 37, and as illumination means, a cold cathode lamp 200 having electrodes 3 of the present invention in the case wherein the cross section perpendicular to the length direction of the glass tube is rectangular is used.

As described above, since at least the surfaces of the electrodes 3 of the present invention are comprised the nitride, which is composed at least one of Ti, Zr, Hf, Nb and Ta, the cold cathode lamp has a high luminance and a long life.

In general, although image scanners, which are household appliances, are maintenance-free, that is, the image scanners are discarded when the cold cathode lamps are deteriorated without replacing the cold cathode lamps, the liquid-crystal display, which is a reading unit of the present invention, has a high performance since a high-luminance cold cathode lamp is used, and can be used for a long period of time since a long-life cold cathode lamp is used.

As described above, at least the surfaces of the electrodes 3 of the present invention are comprised the nitride, the nitride is composed at least one of Ti, Zr, Hf, Nb and Ta. Since the nitride which is, composed at least one of Ti, Zr, Hf, Nb and Ta has a low work function and a low cathode-fall voltage, and since the heat generation of the electrode portion is small, much lamp current can be flowed in the same shape and the same size, sputtering rate is lower than Ni, and the wear of the electrodes is small even if more lamp current is flowed than in the case of Ni. Also, amalgam with mercury is little formed.

Therefore, much lamp current can be flowed without enlarging the electrodes compared with conventional nickel electrodes, and a cold cathode lamp of a high luminance and a long life can be obtained.

While this invention has been described in connection with certain preferred embodiments, it is to be understood that the subject matter encompassed by way of this invention is not to be limited to those specific embodiments. On the contrary, it is intended for the subject matter of the invention to include all alternative, modification and equivalents as can be included within the spirit and scope of the following claims.

What is claimed is:

1. A cold cathode lamp comprising:
electrodes fixed on respective ends of a glass tube; and
a rare gas or a rare gas and mercury vapor sealed in said glass tube;
wherein at least surfaces of the electrodes are composed a nitride, said nitride is composed at least one of titanium (Ti), zirconium (Zr), hafnium (Hf), niobium (Nb) and tantalum (Ta).

2. The cold cathode lamp according to claim 1, wherein said electrodes are composed a material, said material is composed at least one of Ti, Zr, Hf, Nb and Ta, and the said nitride is formed by the nitriding treatment of the surfaces of said electrodes.

3. The cold cathode lamp according to claim 1, wherein said electrodes themselves are composed the nitride, said nitride is composed at least one of Ti, Zr, Hf, Nb and Ta.

4. The cold cathode lamp according to claim 1, wherein said electrodes are composed by coating the surfaces thereof with the nitride, said-nitride is composed at least one of Ti, Zr, Hf, Nb and Ta.

5. The cold cathode lamp according to claim 1, wherein a cross section of said glass tube perpendicular to the length direction thereof has a true-round ring shape.

6. The cold cathode lamp according to claim 1, wherein a cross section of said glass tube perpendicular to the length direction thereof has a rectangular ring shape.

7. The cold cathode lamp according to claim 1, wherein a cold cathode fluorescent lamp is composed by providing a layer of a fluorescent material on an internal surface of said glass tube.

8. The cold cathode lamp according to claim 1, wherein said electrodes are bar-shaped.

9. The cold cathode lamp according to claim 2, wherein said electrodes are bar-shaped.

10. The cold cathode lamp according to claim 3, wherein said electrodes are bar-shaped.

11. The cold cathode lamp according to claim 4, wherein said electrodes are bar-shaped.

12. The cold cathode lamp according to claim 1, wherein said electrodes are tubular.

13. The cold cathode lamp according to claim 2, wherein said electrodes are tubular.

14. The cold cathode lamp according to claim 3, wherein said electrodes are tubular.

15. The cold cathode lamp according to claim 4, wherein said electrodes are tubular.

16. The cold cathode lamp according to claim 1, wherein said electrodes are cup-shaped.

17. The cold cathode lamp according to claim 2, wherein said electrodes are cup-shaped.

18. The cold cathode lamp according to claim 3, wherein said electrodes are cup-shaped.

19. The cold cathode lamp according to claim 4, wherein said electrodes are cup-shaped.

20. An electronic instrument composing said cold cathode lamp according to claim 1.

21. The electronic instrument according to claim 20, wherein said cold cathode lamp is used for a backlight of a display unit.

22. The electronic instrument according to claim 21, wherein said display unit is a liquid-crystal display.

23. The electronic instrument according to claim 20, wherein said cold cathode lamp is used for an illumination of a reading unit.

24. The electronic instrument according to claim 23, wherein said reading unit is an image scanner.

25. The electronic instrument according to claim 24, wherein said reading unit is a pen-type scanner.

26. The electronic instrument according to claim 25, wherein said reading unit is digital high scanner.
